(19) United States
(12) Patent Application Publication
(10) Pub. No.: US 2023/0186933 A1
(43) Pub. Date: Jun. 15, 2023

(54) VOICE NOISE REDUCTION METHOD, ELECTRONIC DEVICE, NON-TRANSITORY COMPUTER-READABLE STORAGE MEDIUM

(71) Applicant: Beijing Baidu Netcom Science Technology Co., Ltd., Beijing (CN)

(72) Inventors: Chunliang WANG, Beijing (CN); Jianqiang WEI, Beijing (CN); Guochang ZHANG, Beijing (CN); Libiao YU, Beijing (CN)

(21) Appl. No.: 18/077,307

(22) Filed: Dec. 8, 2022

(30) Foreign Application Priority Data
Dec. 10, 2021 (CN) 202111509740.4

(51) Int. Cl. G10L 21/0216; G10L 25/18

(52) U.S. Cl. CPC G10L 21/0216; G10L 25/18

(57) ABSTRACT

Provided are a voice noise reduction method, an electronic device, and a non-transitory computer-readable storage medium. The specific implementation scheme includes determining a to-be-denoised voice spectrum of a to-be-denoised voice signal; performing feature extraction on the to-be-denoised voice spectrum to obtain a local voice spectral feature of the to-be-denoised voice spectrum; determining a global voice spectral feature of the to-be-denoised voice spectrum according to the local voice spectral feature of the to-be-denoised voice spectrum; and determining a masking matrix of an original voice signal in the to-be-denoised voice signal according to the local voice spectral feature and the global voice spectral feature, and determining the original voice signal according to the to-be-denoised voice spectrum and the masking matrix.

### CROSS-REFERENCE TO RELATED APPLICATION(S)

This application claims priority to Chinese Patent Application No. 202111509740.4 filed Dec. 10, 2021, the disclosure of which is incorporated herein by reference in its entirety.

### TECHNICAL FIELD

The present disclosure relates to the field of computer technologies and, in particular, to the field of voice technologies, for example, a voice noise reduction method, an electronic device, and a non-transitory computer-readable storage medium.

### BACKGROUND

Voice noise reduction is a basic link in an audio processing process and can achieve the removal of the noise part contained in an audio signal, thereby preventing the noise from affecting the user experience in voice calls or human-computer voice interaction.

In many practical application scenarios, many types of noise are contained in voice information, for example, regular noise continuously emitted by the machine during operating, and irregular noise such as sudden keyboard sounds, door closing sounds, or collision sounds. Therefore, how to ensure the robustness of the voice noise reduction method under different noise scenarios is one of key concerns of researchers.

### SUMMARY

The present disclosure provides a voice noise reduction method, an electronic device, and a non-transitory computer-readable storage medium.

According to an embodiment of the present disclosure, a voice noise reduction method is provided and includes steps described below.

A to-be-denoised voice spectrum of a to-be-denoised voice signal is determined.

Feature extraction is performed on the to-be-denoised voice spectrum to obtain a local voice spectral feature of the to-be-denoised voice spectrum.

A global voice spectral feature of the to-be-denoised voice spectrum is determined according to the local voice spectral feature of the to-be-denoised voice spectrum.

A masking matrix of an original voice signal in the to-be-denoised voice signal is determined according to the local voice spectral feature and the global voice spectral feature, and the original voice signal is determined according to the to-be-denoised voice spectrum and the masking matrix.

According to another embodiment of the present disclosure, an electronic device is provided and includes at least one processor and a memory communicatively connected to the at least one processor.

The memory stores instructions executable by the at least one processor to cause the at least one processor to perform determining a to-be-denoised voice spectrum of a to-be-denoised voice signal; performing feature extraction on the to-be-denoised voice spectrum to obtain a local voice spectral feature of the to-be-denoised voice spectrum; determining a global voice spectral feature of the to-be-denoised voice spectrum according to the local voice spectral feature of the to-be-denoised voice spectrum; and determining a masking matrix of an original voice signal in the to-be-denoised voice signal according to the local voice spectral feature and the global voice spectral feature, and determining the original voice signal according to the to-be-denoised voice spectrum and the masking matrix.

According to another embodiment of the present disclosure, a non-transitory computer-readable storage medium storing computer instructions is provided. The computer instructions are configured to cause a computer to perform determining a to-be-denoised voice spectrum of a to-be-denoised voice signal; performing feature extraction on the to-be-denoised voice spectrum to obtain a local voice spectral feature of the to-be-denoised voice spectrum; determining a global voice spectral feature of the to-be-denoised voice spectrum according to the local voice spectral feature of the to-be-denoised voice spectrum; and determining a masking matrix of an original voice signal in the to-be-denoised voice signal according to the local voice spectral feature and the global voice spectral feature, and determining the original voice signal according to the to-be-denoised voice spectrum and the masking matrix.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1A is a schematic diagram of a voice noise reduction method according to an embodiment of the present disclosure;

FIG. 1B is a network structure diagram of a deep neural network according to an embodiment of the present disclosure;

FIG. 2A is a schematic diagram of a voice noise reduction method according to an embodiment of the present disclosure;

FIG. 2B is a structural diagram of a network module in a deep neural network according to an embodiment of the present disclosure;

FIG. 3A is a schematic diagram of a voice noise reduction method according to an embodiment of the present disclosure;

FIG. 3B is a network structure diagram of a convolutional neural network according to an embodiment of the present disclosure;

FIG. 4 is a schematic diagram of a voice noise reduction apparatus according to an embodiment of the present disclosure; and

FIG. 5 is a block diagram of an electronic device for performing a voice noise reduction method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it will be appreciated by those having ordinary skill in the art that various changes and modifications may be made to the embodiments described herein without departing from the scope and spirit of the present disclosure. Similarly, description of well-known functions and constructions is omitted hereinafter for clarity and conciseness.

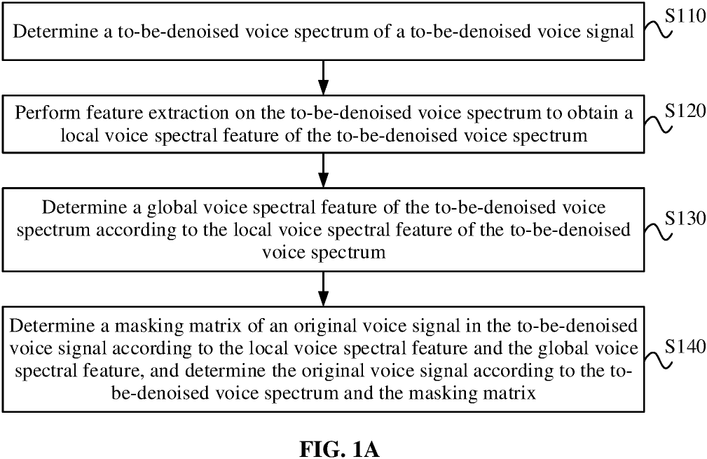

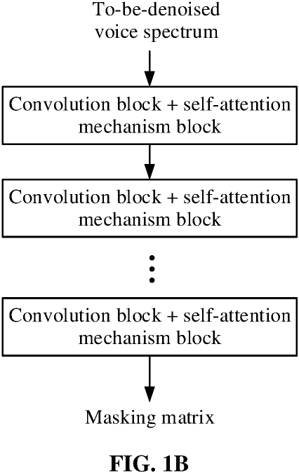

FIG. 1A is a schematic diagram of a voice noise reduction method according to an embodiment of the present disclosure. This embodiment may be applied to a case of voice noise reduction through a convolutional neural network and a self-attention mechanism. The voice noise reduction method of this embodiment may be performed by a voice noise reduction apparatus. The apparatus may be implemented by software and/or hardware and is configured in an electronic device having a certain data computing capability. The electronic device may be a client device or a server device. The client device is, for example, a mobile phone, a tablet computer, an in-vehicle terminal, a desktop computer and the like.

In S110, a to-be-denoised voice spectrum of a to-be-denoised voice signal is determined.

The to-be-denoised voice signal is a voice signal that contains both an original voice signal and a noise signal. According to characteristics of the noise, the noise contained in the to-be-denoised voice signal may be divided into steady-state noise, transient noise, voice interference and other noise.

The steady-state noise refers to regular noise that does not change suddenly with time, for example, noise continuously emitted by the machine during operating or the bustling background sound. The transient noise is irregular noise that appears and disappears suddenly, such as keyboard sounds, door closing sounds, knocks, or collision sounds. The voice interference refers to sounds made by a non-target person in a multi-person scenario. For example, when the voice of person A is collected, the voice of person B around person A is simultaneously collected.

At present, the commonly used voice noise reduction methods may be divided into a traditional signal processing method and a voice noise reduction method based on a neural network. In the traditional signal processing method, a prior assumption needs to be performed on features of noise when noise reduction is performed. For example, a spectral feature of the noise is extracted in advance, and a noise spectrum is subtracted from the to-be-denoised voice spectrum, so as to obtain an original voice spectrum. This method may have a good noise reduction effect when the to-be-denoised voice signal contains the steady-state noise, but the noise reduction effect for the transient noise cannot satisfy expectations.

In the existing voice noise reduction method based on the neural network, time-frequency masking of the original voice signal is often estimated through the neural network or a spectrum of the to-be-denoised voice signal is directly mapped to a spectrum of the original voice signal, so as to obtain the original voice. To ensure the performance of voice noise reduction, a neural network with a relatively large depth and width is generally needed, resulting in a very large amount of computation for voice noise reduction, making the voice noise reduction process impossible to be implemented on lightweight computing devices.

In the embodiments of the present disclosure, when noise reduction is performed on the to-be-denoised voice signal, the to-be-denoised voice spectrum of the to-be-denoised voice signal is determined first, so as to calculate a masking matrix of the to-be-denoised voice signal for the to-be-denoised voice spectrum. In an embodiment, a time-frequency domain analysis of the to-be-denoised voice may be performed through a short-time Fourier transform, so as to obtain a real part spectrum and an imaginary part spectrum of the to-be-denoised voice signal. Further, the real part spectrum and the imaginary part spectrum are spliced together, so as to form a dual-channel to-be-denoised voice spectrum.

By way of example, the short-time Fourier transform is performed on the to-be-denoised voice signal, so as to obtain a real part spectrum with a dimension of 100*64 and an imaginary part spectrum with a dimension of 100*64, where a time dimension is 100 and a frequency dimension is 64. The real part spectrum and the imaginary part spectrum are spliced, so as to obtain the to-be-denoised voice spectrum with a dimension of 100*64*2, where 2 refers to the number of channels of the to-be-denoised voice spectrum.

In S120, feature extraction is performed on the to-be-denoised voice spectrum to obtain a local voice spectral feature of the to-be-denoised voice spectrum.

The local voice spectral feature is used for calculating the masking matrix of the original voice signal in the to-be-denoised voice signal, and the feature extraction is performed on the to-be-denoised voice spectrum so as to obtain the local voice spectral feature. By way of example, the feature extraction is performed on the to-be-denoised voice spectrum through one or more layers of convolutional neural networks, so as to obtain the local voice spectral feature.

In the embodiments of the present disclosure, the to-be-denoised voice spectrum is inputted to a deep neural network model, so as to acquire the masking matrix of the original voice signal in the to-be-denoised voice signal outputted by the deep neural network model. As shown in FIG. 1B, the deep neural network model includes at least one layer of network modules, and each layer of network modules includes a convolution block and a self-attention mechanism block. The convolution block includes at least one layer of convolutional neural network. By way of example, the deep neural network model includes four layers of network modules, and the convolution block includes three layers of convolutional neural networks.

The to-be-denoised voice spectrum is inputted into the convolution block in the deep neural network model, and the feature extraction is performed on the to-be-denoised voice spectrum through multiple layers of convolutional neural networks included in the convolution block, so as to obtain the local voice spectral feature of the to-be-denoised voice spectrum. The local voice spectral feature is extracted by using the advantages of the convolutional neural network in local feature extraction, and the masking matrix of the original voice signal in the to-be-denoised voice signal is calculated by using the extracted local voice spectral feature, thereby improving the performance of voice noise reduction.

By way of example, the convolutional neural network includes a convolutional layer, an activation layer and a normalization layer, and a residual connection structure connecting an input of the convolutional layer and an output of the normalization layer. The convolutional neural network in the convolution block may perform a convolution operation on the inputted to-be-denoised voice spectrum through the convolutional layer, input a result of the convolution operation to the activation layer, and perform batch normalization on an output result of the activation layer through the normalization layer. Finally, through the residual connection structure, the input of the convolutional layer and the output of the normalization layer are superimposed, so as to obtain an output result of this layer of convolutional neural network. Finally, the output result of the last layer of the convolutional neural network may be used as the local voice spectral feature outputted by the convolution block.

In S130, a global voice spectral feature of the to-be-denoised voice spectrum is determined according to the local voice spectral feature of the to-be-denoised voice spectrum.

The global voice spectral feature is used for calculating a time-frequency masking matrix of the original voice signal in the to-be-denoised voice signal, and the global voice spectral feature is obtained by performing the feature extraction on the to-be-denoised voice spectrum. By way of example, a self-attention operation is performed on the local voice spectral feature, so as to obtain the global voice spectral feature. At the same time, the masking matrix of the original voice signal in the to-be-denoised voice signal is calculated by using the local voice spectral feature and the global voice spectral feature, thereby improving the performance of voice noise reduction by using the advantages of the self-attention mechanism in global feature modeling and the advantages of the convolutional neural network in local feature modeling.

In addition, in the voice noise reduction process, the feature extraction needs to be performed on each point in the to-be-denoised voice spectrum, so as to obtain local voice spectral feature with the relatively high time dimension and the relatively high frequency dimension. If the self-attention operation is performed directly on the local voice spectral feature, the amount of computation is relatively large. The self-attention mechanism may be split into a time-axis attention mechanism and a frequency-axis attention mechanism for respective feature processing, so as to obtain the global voice spectral feature, thereby greatly reducing the amount of computation of the feature extraction.

In the embodiments of the present disclosure, the local voice spectral feature of the to-be-denoised voice spectrum is further processed, so as to determine the global voice spectral feature of the to-be-denoised voice spectrum. In an embodiment, the self-attention operation may be performed on the local voice spectral feature, so as to obtain the global voice spectral feature. By way of example, the self-attention mechanism is split into the frequency-axis attention mechanism and the time-axis attention mechanism. First, the self-attention operation is performed on the local voice spectral feature in a frequency axis through the frequency-axis attention mechanism so that the self-attention operation is performed on an output result of the frequency-axis attention mechanism in the time dimension, thereby obtaining the global voice spectral feature. Of course, it is also feasible that the self-attention operation in the time dimension may be performed first and then the self-attention operation in the frequency dimension is performed.

In S140, a masking matrix of an original voice signal in the to-be-denoised voice signal is determined according to the local voice spectral feature and the global voice spectral feature, and the original voice signal is determined according to the to-be-denoised voice spectrum and the masking matrix.

In the embodiments of the present disclosure, the masking matrix of the original voice signal in the to-be-denoised voice signal is calculated by using the local voice spectral feature and the global voice spectral feature of the to-be-denoised voice spectrum. Finally, the original voice signal is determined according to the to-be-denoised voice spectrum and the masking matrix. In an embodiment, data splicing may be performed on the local voice spectral feature and the global voice spectral feature, and then the convolution operation is performed on a splicing result, so as to obtain the masking matrix of the original voice signal. Finally, the to-be-denoised voice spectrum is multiplied by the masking matrix so as to obtain an original voice spectrum of the original voice signal, and an inverse Fourier transform is performed on the original voice spectrum so as to obtain the original voice signal.

By way of example, data splicing is performed on a 24-channel local voice spectral feature and a 24-channel global voice spectral feature, so as to obtain 48-channel spliced data. Further, the spliced data is convolved so as to reduce the number of channels of the spliced data to 2 channels, and the obtained 2-channel data is used as the masking matrix. Further, the 2-channel masking matrix may be multiplied by the to-be-denoised voice spectrum, so as to obtain the original voice spectrum of the original voice signal. Finally, the inverse Fourier transform may be performed on the obtained original voice spectrum, so as to obtain the original voice signal.

The masking matrix of the original voice signal is calculated by using the local voice spectral feature and the global voice spectral feature of the to-be-denoised voice spectrum, thereby improving the performance of voice noise reduction by using the advantages of the self-attention mechanism in global feature modeling and the advantages of the convolutional neural network in local feature modeling.

In the technical schemes of the embodiments of the present disclosure, the local voice spectral feature and the global voice spectral feature of the to-be-denoised voice spectrum are extracted, the masking matrix of the original voice signal in the to-be-denoised voice signal is calculated according to the local voice spectral feature and the global voice spectral feature, and finally, the original voice signal is determined according to the masking matrix and the to-be-denoised voice spectrum, thereby improving the performance of voice noise reduction in conjunction with the advantages of local and global modeling features.

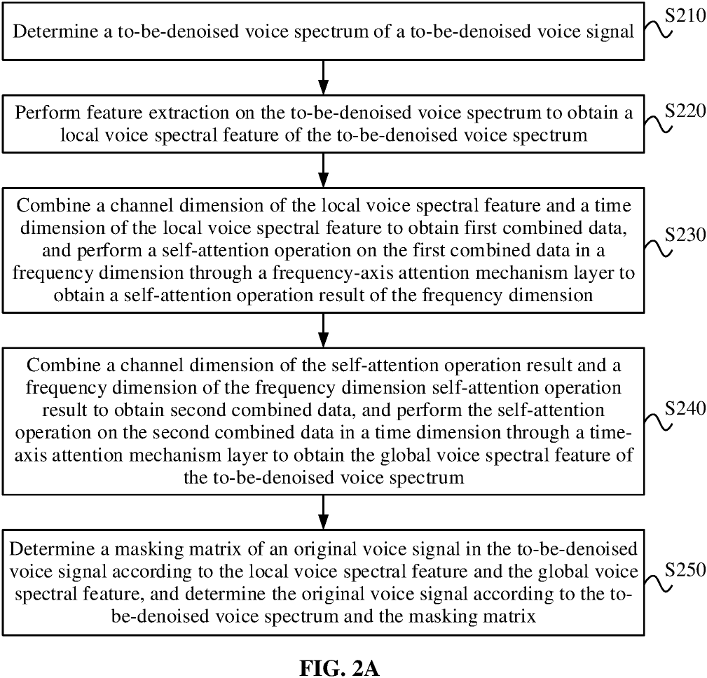

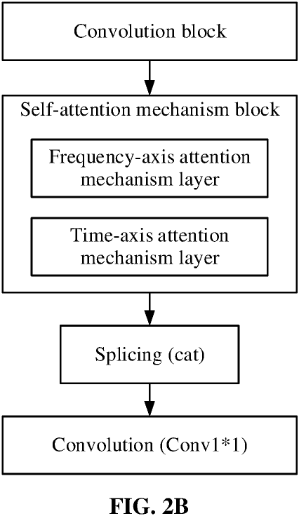

FIG. 2A is a schematic diagram of a voice noise reduction method according to an embodiment of the present disclosure. Further refinement is made based on the preceding embodiments, and specific steps in which the global voice spectral feature of the to-be-denoised voice spectrum is determined according to the local voice spectral feature of the to-be-denoised voice spectrum are provided. The voice noise reduction method according to the embodiment of the present disclosure is described hereinafter in conjunction with FIG. 2A. The method includes steps below.

In S210, a to-be-denoised voice spectrum of a to-be-denoised voice signal is determined.

In S220, feature extraction is performed on the to-be-denoised voice spectrum to obtain a local voice spectral feature of the to-be-denoised voice spectrum.

In an embodiment, the to-be-denoised voice spectrum and the local voice spectral feature have a same dimension in a time domain and a same dimension in a frequency domain.

In the voice noise reduction process, the feature extraction needs to be performed on each point in the to-be-denoised voice spectrum. Therefore, when the feature extraction is performed on the to-be-denoised voice spectrum, the convolution operation is performed on the to-be-denoised voice spectrum with a step of 1, so as to obtain the local voice spectral feature. The feature extraction is performed with a step of 1, and the finally obtained local voice spectral feature and the to-be-denoised voice spectrum have the same dimension in the time domain and the same dimension in the frequency domain; and the feature extraction may also be performed on each point in the to-be-denoised voice spectrum so that the feature is not lost in the convolution process, thereby improving the performance of voice noise reduction.

In a specific example, the to-be-denoised voice spectrum includes two channels, which are a real part spectrum and an imaginary part spectrum. In each channel, the dimension of the time domain is 100, and the dimension of the frequency domain is 64, that is, a spectral feature of the to-be-denoised voice is 100*64*2; and the convolution operation with a step of 1 is performed on the spectral feature of the to-be-denoised voice through 24 convolution kernels each with a size of 3*3, so as to obtain the local voice spectral feature with a dimension of 100*64*24. The to-be-denoised voice spectrum and the local voice spectrum feature both have a dimension of 100 in the time domain and a dimension of 64 in the frequency domain, thereby preventing the feature in the convolution process from being lost; and the feature extraction may be performed on each point in the to-be-denoised voice spectrum, thereby ensuring the effect of voice noise reduction. Moreover, the feature of the to-be-denoised voice spectrum is mapped to a higher dimension through 24 convolution kernels, thereby reducing the loss of information in the to-be-denoised voice spectrum and improving the effect of voice noise reduction.

In S230, a channel dimension of the local voice spectral feature and a time dimension of the local voice spectral feature are combined to obtain first combined data, and a self-attention operation is performed on the first combined data in a frequency dimension through a frequency-axis attention mechanism layer to obtain a self-attention operation result of the frequency dimension.

The deep neural network model for calculating the masking matrix in this embodiment includes at least one layer of network modules and each layer of network modules includes a convolution block and a self-attention mechanism block. In an embodiment, the structure of each layer of network modules is shown in FIG. 2B and includes the convolution block and the self-attention mechanism block, where the self-attention mechanism block includes a frequency-axis attention mechanism layer and a time-axis attention mechanism layer.

To improve the effect of voice noise reduction by using the advantages of the self-attention mechanism in global feature modeling, the local voice spectral feature outputted by the convolution block may be processed by the self-attention mechanism block so as to obtain the global voice spectral feature. In an embodiment, first, the channel dimension and the time dimension of the local voice spectral feature are combined so as to obtain the first combined data. Further, the self-attention operation is performed on the first combined data in the frequency dimension through the frequency-axis attention mechanism layer so as to obtain the self-attention operation result of the frequency dimension.

In a specific example, the dimension of the local voice spectral feature is 100*64*24, where the dimension of the time domain is 100, the dimension of the frequency domain is 64, and the number of channels is 24. The self-attention mechanism is split into the frequency-axis attention mechanism and the time-axis attention mechanism. To perform the self-attention operation on the frequency dimension of the local voice spectral feature, the channel dimension and the time dimension of the local voice spectral feature may be combined so as to obtain the first combined data whose dimension is (100*24)*64. Further, the self-attention operation is performed on the first combined data in the frequency dimension through the frequency-axis attention mechanism layer so as to obtain the self-attention operation result of the frequency dimension, where the dimension of the self-attention operation result is also 100*64*24.

In S240, a channel dimension of the self-attention operation result of the frequency dimension and a frequency dimension of the self-attention operation result of the frequency dimension are combined to obtain second combined data, and the self-attention operation is performed on the second combined data in a time dimension through a time-axis attention mechanism layer to obtain the global voice spectral feature of the to-be-denoised voice spectrum.

After the self-attention operation is performed on the local voice spectral feature in the frequency dimension, further, the channel dimension and the frequency dimension of the self-attention operation result of the frequency dimension are combined so as to obtain the second combined data. Further, the self-attention operation is performed on the second combined data in the time dimension through the time-axis attention mechanism layer so as to obtain the global voice spectral feature of the to-be-denoised voice spectrum. In the embodiments of the present disclosure, the self-attention mechanism is split into the frequency-axis attention mechanism and the time-axis attention mechanism, and global voice spectral feature extraction is performed in two steps, thereby reducing the amount of computation and improving the efficiency of voice noise reduction.

In a specific example, the dimension of the self-attention operation result of the frequency dimension is 100*64*24, where the dimension of the time domain is 100, the dimension of the frequency domain is 64, and the number of channels is 24. Then, the channel dimension and the frequency dimension are combined so as to obtain the second combined data whose dimension is 100*(64*24). Further, the self-attention operation is performed on the second combined data in the time dimension through the time-axis attention mechanism layer so as to obtain a self-attention operation result of the time dimension, where the dimension of the self-attention operation result is also 100*64*24.

It is to be noted that to further optimize the global voice spectral feature extraction process, the residual connection structure may be set in the frequency-axis attention mechanism layer and the time-axis attention mechanism layer respectively, and the input of the frequency-axis attention mechanism layer and the output of the time-axis attention mechanism layer are superimposed, thereby reducing the information loss caused by the feature extraction and further improving the performance of voice noise reduction. Moreover, in practical applications, it is also feasible that the self-attention operation in the time dimension may be performed first and then the self-attention operation in the frequency dimension is performed, and the execution order is not limited in this embodiment.

In S250, a masking matrix of an original voice signal in the to-be-denoised voice signal is determined according to the local voice spectral feature and the global voice spectral feature, and the original voice signal is determined according to the to-be-denoised voice spectrum and the masking matrix.

After the local voice spectral feature and the global voice spectral feature of the to-be-denoised voice spectrum are extracted, the local voice spectral feature and the global voice spectral feature are spliced so as to obtain spliced data. Further, according to the number of channels actually required, the convolution operation is performed on the spliced data so as to obtain the output of the current network module. The output of the last network module is the masking matrix.

For the last layer of network modules, to obtain the masking matrix matching the dimension of the dual-channel to-be-denoised voice spectrum, the spliced data is convolved, so as to obtain a dual-channel masking matrix. Finally, the to-be-denoised voice spectrum is multiplied by the masking matrix so as to obtain the original voice spectrum of the original voice signal in the to-be-denoised voice signal, and the inverse Fourier transform is performed on the original voice spectrum so as to obtain the original voice signal.

In a specific example, the dimension of the extracted local voice spectral feature and the dimension of the extracted global voice spectral feature of the to-be-denoised voice spectrum are both 100*64*24, where the dimension of the time domain is 100, the dimension of the frequency domain is 64, and the number of channels is 24. After the local voice spectral feature and the global voice spectral feature are spliced, the dimension of the spliced data is 100*64*48. Further, the spliced spectral feature is convolved by using two convolution kernels each with a size of 1, so as to obtain a masking matrix with a dimension of 100*64*2. Finally, the to-be-denoised voice spectrum is multiplied by the masking matrix so as to obtain the original voice spectrum of the original voice signal in the to-be-denoised voice signal, and the inverse Fourier transform is performed on the original voice spectrum so as to obtain the original voice signal.

According to the technical schemes of the embodiments of the present disclosure, the local voice spectral feature of the to-be-denoised voice spectrum is extracted, the self-attention operation in the frequency dimension and the self-attention operation in the time dimension are performed on the local voice spectral feature respectively so as to obtain the global voice spectral feature, the masking matrix of the original voice signal in the to-be-denoised voice signal is calculated according to the local voice spectral feature and the global voice spectral feature, and finally, the original voice signal is determined according to the to-be-denoised voice spectrum and the masking matrix. In this manner, on the one hand, the advantages of the local and global modeling features are combined so that the performance of voice noise reduction is improved; on the other hand, the attention mechanism operation is split into a frequency dimension self-attention operation and a time dimension self-attention operation so that the amount of computation of the self-attention operation may be reduced and the efficiency of voice noise reduction is improved.

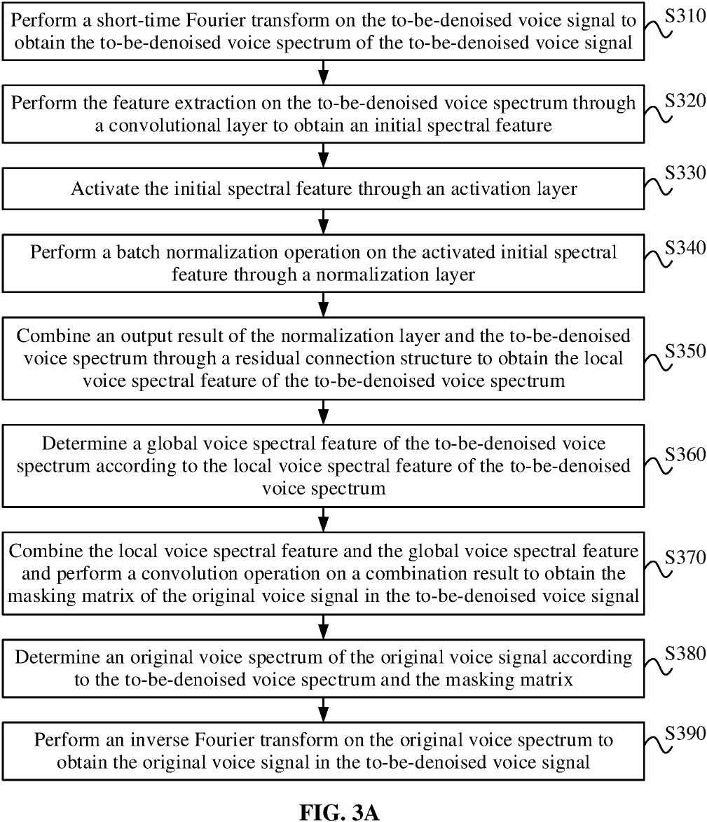

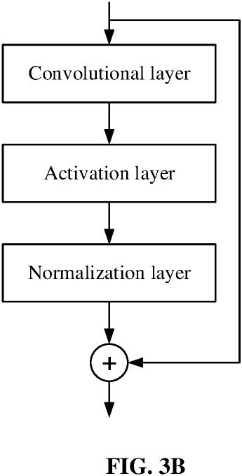

FIG. 3A is a schematic diagram of a voice noise reduction method according to an embodiment of the present disclosure. Further refinement is made based on the preceding embodiments, specific steps in which the to-be-denoised voice spectrum of the to-be-denoised voice signal is determined and the feature extraction is performed on the to-be-denoised voice spectrum to obtain the local voice spectral feature of the to-be-denoised voice spectrum are provided, and specific steps in which the masking matrix of the original voice signal in the to-be-denoised voice signal is determined according to the local voice spectral feature and the global voice spectral feature and the original voice signal is determined according to the to-be-denoised voice spectrum and the masking matrix are provided. The voice noise reduction method according to the embodiment of the present disclosure is described hereinafter in conjunction with FIG. 3A. The method includes steps below.

In S310, a short-time Fourier transform is performed on a to-be-denoised voice signal to obtain a to-be-denoised voice spectrum of the to-be-denoised voice signal.

In the embodiment of the present disclosure, a time-frequency domain analysis of the to-be-denoised voice signal is performed through a short-time Fourier transform, so as to obtain a real part spectrum and an imaginary part spectrum included in the to-be-denoised voice signal, and the real part spectrum and the imaginary part spectrum form a dual-channel to-be-denoised voice spectrum. In the process of the short-time Fourier transform, a length of a window determines the time dimension and the frequency dimension. The longer the length of the window is, the longer the intercepted signal is. After the short-time Fourier transform, the frequency dimension is higher and the time dimension is lower. The time dimension and the frequency dimension may be balanced according to the length of the window, thereby improving the effect of voice noise reduction.

In S320, feature extraction is performed on the to-be-denoised voice spectrum through a convolutional layer to obtain an initial spectral feature.

The deep neural network model for calculating the masking matrix in this embodiment includes at least one layer of network modules and each layer of network modules includes a convolution block and a self-attention mechanism block. The convolution block includes at least one layer of convolutional neural network. The structure of each layer of convolutional neural network is shown in FIG. 3B and includes a convolutional layer, an activation layer and a normalization layer, and a residual connection structure connecting an input of the convolutional layer and an output of the normalization layer. By way of example, each convolution block includes three layers of convolutional neural networks.

In the embodiments of the present disclosure, the convolution block in the adopted deep neural network model performs the feature extraction on the to-be-denoised voice spectrum, so as to obtain the initial spectrum feature. In an embodiment, multiple convolution processing is performed through multiple layers of convolutional neural networks in the convolution block, so as to obtain the initial spectral feature.

In a specific example, the to-be-denoised voice spectrum is a dual-channel voice spectrum, and the specific dimension is 100*64*2. The to-be-denoised voice spectrum is inputted into the convolutional layer of the convolutional neural network, and the to-be-denoised voice spectrum is convolved through 24 convolution kernels each with a size of 100*64*2, so as to obtain the initial spectral feature of the to-be-denoised voice spectrum with a dimension of 100*64*24. The feature of to-be-denoised voice spectrum is mapped to a higher dimension by adding channels, thereby reducing the information loss of the to-be-denoised voice spectrum and improving the performance of voice noise reduction.

In S330, the initial spectral feature is activated through an activation layer.

After the feature of the to-be-denoised voice spectrum is convolved so as to obtain the initial spectral feature, the initial spectral feature is activated by an activation function contained in the activation layer. By way of example, the activation function may be a Prelu function, a Sigmoid function, or a Softmax function, or the like.

In S340, a batch normalization operation is performed on the activated initial spectral feature through a normalization layer.

After the initial spectral feature is activated, the batch normalization operation is further performed on the activated initial spectral feature through the normalization layer, thereby increasing the generalization capability of the model.

The local voice spectral feature is extracted through the convolutional neural network, and the advantages of the convolutional neural network in local feature modeling may be used so that the reliability of voice noise reduction is improved.

In S350, an output result of the normalization layer and the to-be-denoised voice spectrum are combined through a residual connection structure to obtain the local voice spectral feature of the to-be-denoised voice spectrum.

It is worth noting that, to avoid the network degradation caused by the increase of the number of network layers, the residual connection structure is set in the convolutional neural network, and the input of the convolutional layer and the output of the normalization layer are superimposed, so as to obtain an output result of the convolutional neural network.

After the output result of the normalization layer is obtained, the input and output results of the convolutional neural network are further superimposed through the residual connection structure of the convolutional neural network. In an embodiment, the output result of the normalization layer and the to-be-denoised voice spectrum inputted into the convolutional layer are superimposed, so as to obtain the local voice spectral feature of the to-be-denoised voice spectrum. Through the residual connection structure of the convolutional neural network, the network degradation caused by the increase of the number of network layers can be avoided and the effect of voice noise reduction can be optimized.

In S360, a global voice spectral feature of the to-be-denoised voice spectrum is determined according to the local voice spectral feature of the to-be-denoised voice spectrum.

In S370, the local voice spectral feature and the global voice spectral feature are combined to obtain a combination result and a convolution operation is performed on the combination result to obtain the masking matrix of the original voice signal in the to-be-denoised voice signal.

To have both the advantages of the convolutional neural network in local feature modeling and the advantages of the self-attention mechanism in global feature modeling, the local voice spectral feature and the global voice spectral feature outputted by the convolutional neural network are combined so as to obtain a combined spectral feature. However, since the spectrum of the to-be-denoised voice signal is a dual-channel spectrum including the real part spectrum and the imaginary part spectrum, and the local voice spectral feature and the global voice spectral feature are spectral features in the case where channels are added, the obtained spectral feature after the local voice spectral feature and the global voice spectral feature are combined have much more than 2 channels. Therefore, the convolution operation may be performed on the combined spectral feature so that the number of channels is reduced and the masking matrix of the original voice signal is obtained.

In S380, an original voice spectrum of the original voice signal is determined according to the to-be-denoised voice spectrum and the masking matrix.

After the masking matrix of the original voice signal is obtained, the to-be-denoised voice spectrum may be directly multiplied by the masking matrix, so as to obtain the original voice spectrum of the original voice signal. Since the masking matrix is calculated based on the global voice spectral feature and the local voice spectral feature, not only the modeling advantages of the convolutional neural network for local features are used but also the self-attention mechanism is used so as to obtain a long-distance timing dependent relationship before and after the to-be-denoised voice signal, thereby improving the performance of voice noise reduction. Moreover, compared with the manner of using only the convolutional neural network, the combination of the convolutional neural network and the self-attention mechanism may achieve the same noise reduction effect under the condition of smaller network depth and network width, thereby reducing the amount of computation in the voice noise reduction process.

In S390, an inverse Fourier transform is performed on the original voice spectrum to obtain the original voice signal in the to-be-denoised voice signal.

In the technical schemes of the embodiments of the present disclosure, the local voice spectral feature and the global voice spectral feature of the to-be-denoised voice spectrum are extracted, the masking matrix of the original voice signal in the to-be-denoised voice signal is calculated according to the local voice spectral feature and the global voice spectral feature, and finally, the original voice signal is determined according to the masking matrix and the to-be-denoised voice spectrum, thereby improving the performance of voice noise reduction in conjunction with the advantages of local and global modeling features.

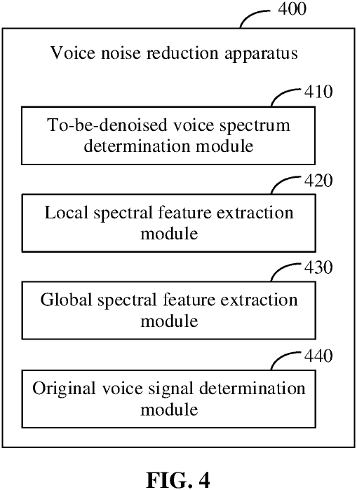

According to an embodiment of the present disclosure, FIG. 4 is a schematic diagram of a voice noise reduction apparatus according to an embodiment of the present disclosure, and the embodiment of the present disclosure is applicable to the case of performing voice noise reduction through a convolutional neural network and a self-attention mechanism. The apparatus is implemented by software and/or hardware and is configured in an electronic device having a certain data computing capability.

A voice noise reduction apparatus 400 shown in FIG. 4 includes a to-be-denoised voice spectrum determination module 410, a local spectral feature extraction module 420, a global spectral feature determination module 430, and an original voice signal determination module 440.

The to-be-denoised voice spectrum determination module 410 is configured to determine a to-be-denoised voice spectrum of a to-be-denoised voice signal.

The local spectral feature extraction module 420 is configured to perform feature extraction on the to-be-denoised voice spectrum to obtain a local voice spectral feature of the to-be-denoised voice spectrum.

The global spectral feature determination module 430 is configured to determine a global voice spectral feature of the to-be-denoised voice spectrum according to the local voice spectral feature of the to-be-denoised voice spectrum.

The original voice signal determination module 440 is configured to determine a masking matrix of an original voice signal in the to-be-denoised voice signal according to the local voice spectral feature and the global voice spectral feature and determine the original voice signal according to the to-be-denoised voice spectrum and the masking matrix.

In the technical schemes of the embodiments of the present disclosure, the local voice spectral feature and the global voice spectral feature of the to-be-denoised voice spectrum are extracted, the masking matrix of the original voice signal in the to-be-denoised voice signal is calculated according to the local voice spectral feature and the global voice spectral feature, and finally, the original voice signal is determined according to the masking matrix and the to-be-denoised voice spectrum, thereby improving the performance of voice noise reduction in conjunction with the advantages of local and global modeling features.

Further, the to-be-denoised voice spectrum and the local voice spectral feature have a same dimension in a time domain and a same dimension in a frequency domain.

Further, the global spectral feature determination module 430 includes a first attention mechanism unit and a second attention mechanism unit.

The first attention mechanism unit is configured to combine a channel dimension of the local voice spectral feature and a time dimension of the local voice spectral feature to obtain first combined data and perform a self-attention operation on the first combined data in a frequency dimension through a frequency-axis attention mechanism layer to obtain a self-attention operation result of the frequency dimension.

The second attention mechanism unit is configured to combine a channel dimension of the self-attention operation result of the frequency dimension and a frequency dimension of the self-attention operation result of the frequency dimension to obtain second combined data and perform the self-attention operation on the second combined data in a time dimension through a time-axis attention mechanism layer to obtain the global voice spectral feature of the to-be-denoised voice spectrum.

Further, the local spectral feature extraction module 420 includes a convolution unit, an activation unit, a normalization unit, and a local spectral feature determination unit.

The convolution unit is configured to perform the feature extraction on the to-be-denoised voice spectrum through a convolutional layer to obtain an initial spectral feature.

The activation unit is configured to activate the initial spectral feature through an activation layer.

The normalization unit is configured to perform a batch normalization operation on the activated initial spectral feature through a normalization layer.

The local spectral feature determination unit is configured to combine an output result of the normalization layer and the to-be-denoised voice spectrum through a residual connection structure to obtain the local voice spectral feature of the to-be-denoised voice spectrum.

Further, the to-be-denoised voice spectrum determination module 410 includes a to-be-denoised voice spectrum determination unit.

The to-be-denoised voice spectrum determination unit is configured to perform a short-time Fourier transform on the to-be-denoised voice signal to obtain the to-be-denoised voice spectrum of the to-be-denoised voice signal.

The original voice signal determination module 440 includes an original voice spectrum determination unit and an original voice signal determination unit.

The original voice spectrum determination unit is configured to determine an original voice spectrum of the original voice signal according to the to-be-denoised voice spectrum and the masking matrix.

The original voice signal determination unit is configured to perform an inverse Fourier transform on the original voice spectrum to obtain the original voice signal in the to-be-denoised voice signal.

Further, the original voice signal determination module 440 includes a masking matrix determination unit.

The masking matrix determination unit is configured to combine the local voice spectral feature and the global voice spectral feature to obtain a combination result and perform a convolution operation on the combination result to obtain the masking matrix of the original voice signal in the to-be-denoised voice signal.

The voice noise reduction apparatus according to the embodiments of the present disclosure can perform the voice noise reduction method according to any embodiment of the present disclosure and has functional modules and beneficial effects corresponding to the executed method.

In the technical schemes of the present disclosure, the collection, storage, use, processing, transmission, provision, and disclosure of user personal information involved are in compliance with provisions of relevant laws and regulations and do not violate public order and good customs.

According to the embodiments of the present disclosure, the present disclosure further provides an electronic device, a readable storage medium, and a computer program product.

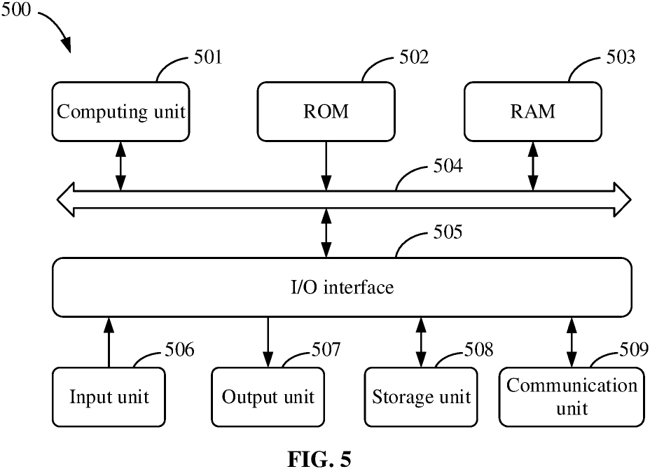

FIG. 5 is a block diagram of an exemplary electronic device 500 that may be configured to implement the embodiments of the present disclosure. Electronic devices are intended to represent various forms of digital computers, for example, a laptop computer, a desktop computer, a worktable, a personal digital assistant, a server, a blade server, a mainframe computer or another applicable computer. Electronic devices may further represent various forms of mobile apparatuses, for example, personal digital assistants, cellphones, smartphones, wearable devices, and other similar computing apparatuses. Herein the shown components, the connections and relationships between these components, and the functions of these components are illustrative only and are not intended to limit the implementation of the present disclosure as described and/or claimed herein.

As shown in FIG. 5, the device 500 includes a computing unit 501. The computing unit 501 may perform various types of appropriate operations and processing based on a computer program stored in a read-only memory (ROM) 502 or a computer program loaded from a storage unit 508 to a random-access memory (RAM) 503. Various programs and data required for operations of a storage device 500 may also be stored in the RAM 503. The computing unit 501, the ROM 502 and the RAM 503 are connected to each other through a bus 504. An input/output (I/O) interface 505 is also connected to the bus 504.

Multiple components in the device 500 are connected to the I/O interface 505. The components include an input unit 506 such as a keyboard and a mouse, an output unit 507 such as various types of displays and speakers, the storage unit 508 such as a magnetic disk and an optical disc, and a communication unit 509 such as a network card, a modem and a wireless communication transceiver. The communication unit 509 allows the device 500 to exchange information/data with other devices over a computer network such as the Internet and/or various telecommunications networks.

The computing unit 501 may be various general-purpose and/or special-purpose processing components having processing and computing capabilities. Examples of the computing unit 501 include, but are not limited to, a central processing unit (CPU), a graphics processing unit (GPU), a special-purpose artificial intelligence (Al) computing chip, a computing unit executing machine learning models and algorithms, a digital signal processor (DSP) and any appropriate processor, controller and microcontroller. The computing unit 501 executes various methods and processing described above, such as the voice noise reduction method. For example, in some embodiments, the video noise reduction method may be implemented as computer software programs tangibly contained in a machine-readable medium such as the storage unit 508. In some embodiments, part or all of computer programs may be loaded and/or installed on the device 500 via the ROM 502 and/or the communication unit 509. When the computer program is loaded to the RAM 503 and executed by the computing unit 501, one or more steps of the preceding voice noise reduction method may be performed. Alternatively, in other embodiments, the computing unit 501 may be configured, in any other suitable manner (for example, by means of firmware), to perform the video noise reduction method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical memory device, a magnetic memory device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

It is to be understood that various forms of the preceding flows may be used with steps reordered, added, or removed. For example, the steps described in the present disclosure may be executed in parallel, in sequence or in a different order as long as the desired results of the technical schemes disclosed in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A voice noise reduction method, comprising:
determining a to-be-denoised voice spectrum of a to-be-denoised voice signal;
performing feature extraction on the to-be-denoised voice spectrum to obtain a local voice spectral feature of the to-be-denoised voice spectrum;
determining a global voice spectral feature of the to-be-denoised voice spectrum according to the local voice spectral feature of the to-be-denoised voice spectrum; and
determining a masking matrix of an original voice signal in the to-be-denoised voice signal according to the local voice spectral feature and the global voice spectral feature, and determining the original voice signal according to the to-be-denoised voice spectrum and the masking matrix.

2. The method of claim 1, wherein the to-be-denoised voice spectrum and the local voice spectral feature have a same dimension in a time domain and a same dimension in a frequency domain.

3. The method of claim 1, wherein determining the global voice spectral feature of the to-be-denoised voice spectrum according to the local voice spectral feature of the to-be-denoised voice spectrum comprises:
combining a channel dimension of the local voice spectral feature and a time dimension of the local voice spectral feature to obtain first combined data, and performing a self-attention operation on the first combined data in a frequency dimension through a frequency-axis attention mechanism layer to obtain a self-attention operation result of the frequency dimension; and
combining a channel dimension of the self-attention operation result of the frequency dimension and a frequency dimension of the self-attention operation result of the frequency dimension to obtain second combined data, and performing the self-attention operation on the second combined data in a time dimension through a time-axis attention mechanism layer to obtain the global voice spectral feature of the to-be-denoised voice spectrum.

4. The method of claim 1, wherein performing the feature extraction on the to-be-denoised voice spectrum to obtain the local voice spectral feature of the to-be-denoised voice spectrum comprises:
performing the feature extraction on the to-be-denoised voice spectrum through a convolutional layer to obtain an initial spectral feature;
activating the initial spectral feature through an activation layer;
performing a batch normalization operation on the activated initial spectral feature through a normalization layer; and
combining an output result of the normalization layer and the to-be-denoised voice spectrum through a residual connection structure to obtain the local voice spectral feature of the to-be-denoised voice spectrum.

5. The method of claim 1, wherein determining the to-be-denoised voice spectrum of the to-be-denoised voice signal comprises:
performing a short-time Fourier transform on the to-be-denoised voice signal to obtain the to-be-denoised voice spectrum of the to-be-denoised voice signal; and
wherein determining the original voice signal according to the to-be-denoised voice spectrum and the masking matrix comprises:
determining an original voice spectrum of the original voice signal according to the to-be-denoised voice spectrum and the masking matrix; and
performing an inverse Fourier transform on the original voice spectrum to obtain the original voice signal in the to-be-denoised voice signal.

6. The method of claim 1, wherein determining the masking matrix of the original voice signal in the to-be-denoised voice signal according to the local voice spectral feature and the global voice spectral feature comprises:
combining the local voice spectral feature and the global voice spectral feature to obtain a combination result and performing a convolution operation on the combination result to obtain the masking matrix of the original voice signal in the to-be-denoised voice signal.

7. An electronic device, comprising:
at least one processor; and
a memory communicatively connected to the at least one processor;
wherein the memory stores instructions executable by the at least one processor, and the instructions, when executed by the at least one processor, cause the at least one processor to perform:
determining a to-be-denoised voice spectrum of a to-be-denoised voice signal;
performing feature extraction on the to-be-denoised voice spectrum to obtain a local voice spectral feature of the to-be-denoised voice spectrum;
determining a global voice spectral feature of the to-be-denoised voice spectrum according to the local voice spectral feature of the to-be-denoised voice spectrum; and
determining a masking matrix of an original voice signal in the to-be-denoised voice signal according to the local voice spectral feature and the global voice spectral feature, and determining the original voice signal according to the to-be-denoised voice spectrum and the masking matrix.

8. The electronic device of claim 7, wherein the to-be-denoised voice spectrum and the local voice spectral feature have a same dimension in a time domain and a same dimension in a frequency domain.

9. The electronic device of claim 7, wherein the instructions, when executed by the at least one processor, cause the at least one processor to perform determining the global voice spectral feature of the to-be-denoised voice spectrum according to the local voice spectral feature of the to-be-denoised voice spectrum in the following way:
combining a channel dimension of the local voice spectral feature and a time dimension of the local voice spectral feature to obtain first combined data, and performing a self-attention operation on the first combined data in a frequency dimension through a frequency-axis attention mechanism layer to obtain a self-attention operation result of the frequency dimension; and
combining a channel dimension of the self-attention operation result of the frequency dimension and a frequency dimension of the self-attention operation result of the frequency dimension to obtain second combined data, and performing the self-attention operation on the second combined data in a time dimension through a time-axis attention mechanism layer to obtain the global voice spectral feature of the to-be-denoised voice spectrum.

10. The electronic device of claim 7, wherein the instructions, when executed by the at least one processor, cause the at least one processor to perform performing the feature extraction on the to-be-denoised voice spectrum to obtain the local voice spectral feature of the to-be-denoised voice spectrum in the following way:
performing the feature extraction on the to-be-denoised voice spectrum through a convolutional layer to obtain an initial spectral feature;
activating the initial spectral feature through an activation layer;
performing a batch normalization operation on the activated initial spectral feature through a normalization layer; and
combining an output result of the normalization layer and the to-be-denoised voice spectrum through a residual connection structure to obtain the local voice spectral feature of the to-be-denoised voice spectrum.

11. The electronic device of claim 7, wherein the instructions, when executed by the at least one processor, cause the at least one processor to perform determining the to-be-denoised voice spectrum of the to-be-denoised voice signal in the following way:
performing a short-time Fourier transform on the to-be-denoised voice signal to obtain the to-be-denoised voice spectrum of the to-be-denoised voice signal; and
wherein the instructions, when executed by the at least one processor, cause the at least one processor to perform determining the original voice signal according to the to-be-denoised voice spectrum and the masking matrix in the following way:
determining an original voice spectrum of the original voice signal according to the to-be-denoised voice spectrum and the masking matrix; and
performing an inverse Fourier transform on the original voice spectrum to obtain the original voice signal in the to-be-denoised voice signal.

12. The electronic device of claim 7, wherein the instructions, when executed by the at least one processor, cause the at least one processor to perform determining the masking matrix of the original voice signal in the to-be-denoised voice signal according to the local voice spectral feature and the global voice spectral feature in the following way:
combining the local voice spectral feature and the global voice spectral feature to obtain a combination result and performing a convolution operation on the combination result to obtain the masking matrix of the original voice signal in the to-be-denoised voice signal.

13. A non-transitory computer-readable storage medium storing computer instructions, wherein the computer instructions are configured to cause a computer to perform:
determining a to-be-denoised voice spectrum of a to-be-denoised voice signal;
performing feature extraction on the to-be-denoised voice spectrum to obtain a local voice spectral feature of the to-be-denoised voice spectrum;
determining a global voice spectral feature of the to-be-denoised voice spectrum according to the local voice spectral feature of the to-be-denoised voice spectrum; and
determining a masking matrix of an original voice signal in the to-be-denoised voice signal according to the local voice spectral feature and the global voice spectral feature, and determining the original voice signal according to the to-be-denoised voice spectrum and the masking matrix.

14. The non-transitory computer-readable storage medium of claim 13, wherein the to-be-denoised voice spectrum and the local voice spectral feature have a same dimension in a time domain and a same dimension in a frequency domain.

15. The non-transitory computer-readable storage medium of claim 13, wherein the computer instructions are configured to cause a computer to perform determining the global voice spectral feature of the to-be-denoised voice spectrum according to the local voice spectral feature of the to-be-denoised voice spectrum in the following way:
combining a channel dimension of the local voice spectral feature and a time dimension of the local voice spectral feature to obtain first combined data, and performing a self-attention operation on the first combined data in a frequency dimension through a frequency-axis attention mechanism layer to obtain a self-attention operation result of the frequency dimension; and
combining a channel dimension of the self-attention operation result of the frequency dimension and a frequency dimension of the self-attention operation result of the frequency dimension to obtain second combined data, and performing the self-attention operation on the second combined data in a time dimension through a time-axis attention mechanism layer to obtain the global voice spectral feature of the to-be-denoised voice spectrum.

16. The non-transitory computer-readable storage medium of claim 13, wherein the computer instructions are configured to cause a computer to perform performing the feature extraction on the to-be-denoised voice spectrum to obtain the local voice spectral feature of the to-be-denoised voice spectrum in the following way:
performing the feature extraction on the to-be-denoised voice spectrum through a convolutional layer to obtain an initial spectral feature;
activating the initial spectral feature through an activation layer;
performing a batch normalization operation on the activated initial spectral feature through a normalization layer; and
combining an output result of the normalization layer and the to-be-denoised voice spectrum through a residual connection structure to obtain the local voice spectral feature of the to-be-denoised voice spectrum.

17. The non-transitory computer-readable storage medium of claim 13, wherein the computer instructions are configured to cause a computer to perform determining the to-be-denoised voice spectrum of the to-be-denoised voice signal in the following way:
performing a short-time Fourier transform on the to-be-denoised voice signal to obtain the to-be-denoised voice spectrum of the to-be-denoised voice signal; and
wherein the computer instructions are configured to cause a computer to perform determining the original voice signal according to the to-be-denoised voice spectrum and the masking matrix in the following way:
determining an original voice spectrum of the original voice signal according to the to-be-denoised voice spectrum and the masking matrix; and
performing an inverse Fourier transform on the original voice spectrum to obtain the original voice signal in the to-be-denoised voice signal.

18. The non-transitory computer-readable storage medium of claim 13, wherein the computer instructions are configured to cause a computer to perform determining the masking matrix of the original voice signal in the to-be-denoised voice signal according to the local voice spectral feature and the global voice spectral feature in the following way:
combining the local voice spectral feature and the global voice spectral feature to obtain a combination result and performing a convolution operation on the combination result to obtain the masking matrix of the original voice signal in the to-be-denoised voice signal.
